(19) United States
(12) Patent Application Publication
(10) Pub. No.: US 2005/0105669 A1
(43) Pub. Date: May 19, 2005

(54) Method for controlling a nuclear fuel pencil

(75) Inventors: Claude Roche, Roquemaure (FR); Fabrice Pavanello, St Laurent Des Arbres (FR)

Correspondence Address: PEARNE & GORDON LLP, 1801 EAST 9TH STREET, SUITE 1200, CLEVELAND, OH, 44114-3108, US

(73) Assignee: Compagnie Generale des Matieres Nucleaires, Velizy-Villacoublay (FR)

(21) Appl. No.: 10/502,874

(22) PCT Filed: Feb. 6, 2003
(86) PCT No.: PCT/FR03/00375

(30) Foreign Application Priority Data
Feb. 8, 2002 (FR) 02/01557

(51) Int. Cl. G21C 19/00

(52) U.S. Cl. 376/260

(57) ABSTRACT

An electromagnetic induction detector (9) is used to check the weld (6) of a plug (3) to a nuclear fuel cladding (2) still containing a spring (5). A weld made using an excessive energy weakens the metallurgical structure of the spring (5) which may reduce the electromagnetic coupling and the signal recorded by the detector (9). A comparison between the peak values of the signal and the plateau value of the signal gives a criterion for estimating the quality of the fuel rods (1).

The purpose of this invention is a method for inspecting a nuclear fuel rod.

Some nuclear fuel rods comprise a cladding containing a stack of fuel pellets closed at one open end by a plug that is subsequently welded. A spring is compressed between the plug and the stack of pellets to hold the stack in place.

Non-destructive tests are carried out to check some characteristics of the assembled rod. Thus, an electromagnetic detector is used to check that the spring is present and the length of the chamber that contains it between the plug and the fuel pellets. The rod is moved in front of the detector, and the detector output signal, which is stronger when the magnetic coupling is locally higher, includes a plateau corresponding to the length of the spring and is limited by two peaks corresponding to the ends of the spring, in which the compressed turns are therefore accumulated and the magnetic coupling is greater. The existence of this characteristic curve proves that the spring has not been forgotten.

The process in question here uses a measurement of this type to determine the quality of the plug weld, based on an innovative reasoning.

It has been observed that the weld quality is strongly dependent on the input energy. If the input energy is excessive, molten metal droplets can be deposited on the spring and affect its state or make it stick to the plug. One particular problem that could arise is that the metallurgical structure of the spring, the cladding or the plug could be modified due to overheating. A rod with a damaged spring must be rejected, in the same way as a rod with a missing spring.

To summarise, the invention relates to a method for the inspection of a nuclear fuel rod with an end plug welded to a cladding, a coil spring being compressed between the plug and the fuel, using an electromagnetic induction detector along which the rod is moved, by measuring a detector output signal, characterised in that it consists of recording a value of the signal at a base portion, obtained at the side of the rod and in the absence of any magnetic coupling with the rod, and another value of the signal and with a peak adjacent to the base portion, where the plug and one end of the spring adjacent to the plug apply maximum magnetic coupling, calculating a ratio of the values of the signal and accepting or rejecting the rod depending on whether the ratio is more than or less than a threshold.

The invention will now be described with reference to the following figures:

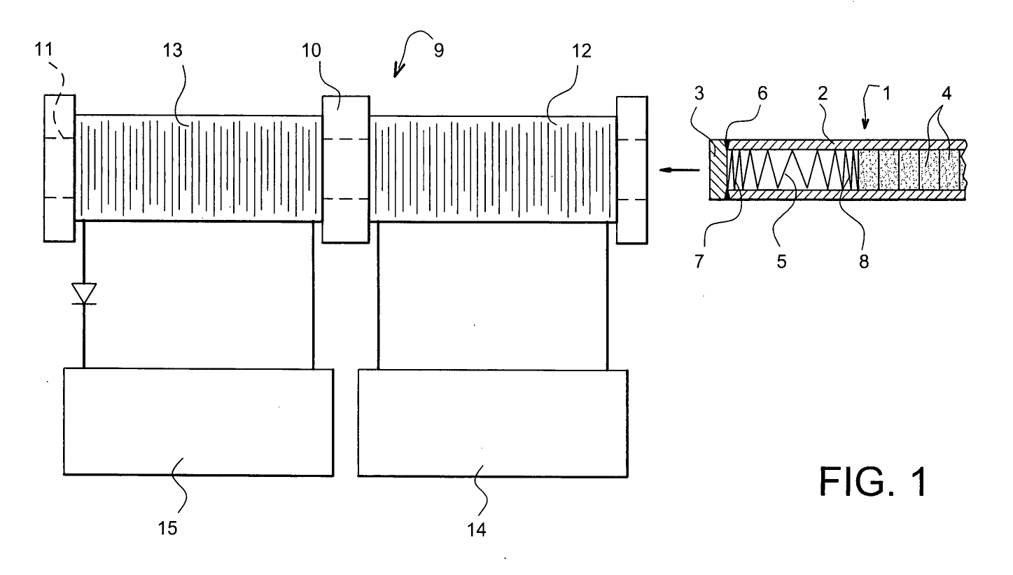

FIG. 1 is a general view of the equipment used for implementation of the process,

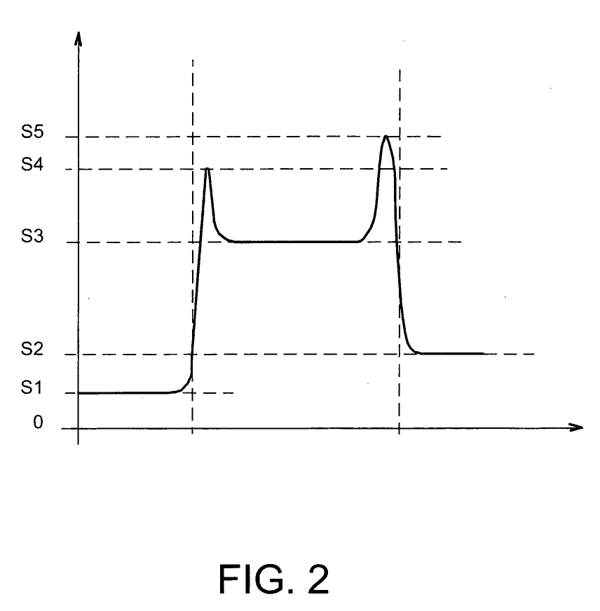

FIG. 2 illustrates the curve obtained.

FIG. 1 shows a rod 1 made of nuclear fuel for which the cladding is marked as reference 2, the top plug is reference 3, the stacked pellets are reference 4, and the spring is reference 5. The weld of the plug 3 to the edge of the cladding 1 is marked reference 6. It extends adjacent to one end 7 of the spring 5, and the other end adjacent to the pellets 4 is marked as reference 8. The inspection is made by a sensor 9 comprising a cylindrical mandrel 10 in which a hole 11 is formed for the passage of the rods 1 and in which two successive outer grooves are formed, into one of which a primary coil is fitted and into the other of which a secondary coil 13 is fitted. An excitation device 14 is placed at the terminals of the coil 12 and a reception device 15 is placed at the terminals of coil 13. Each of the coils 12 and 13 may comprise 530 turns of copper wire with a diameter of one tenth of a millimetre. A sinusoidal electrical signal output from an oscillator is input into the primary coil 12; the frequency of the oscillator may be 1.5 kilohertz and its voltage 2 volts. The secondary coil 13 carries an induced current for which the voltage depends on the magnetic coupling produced by the rod 1. The rod 1 is moved along the detector 9 by passing through the recess 11, to result in a signal with a complex shape shown in FIG. 2. The abscissas express a movement distance and the ordinates a voltage measured by the secondary coil 13. Firstly, a constant value or a base value is recorded corresponding to a lack of magnetic influence of the rod 1, or a no-load test, for which the value S1 is about 2.6 volts in this example. The value of the signal increases suddenly when the magnetic coupling produced mainly by the end 7 of the spring 5 is felt, up to a peak value S4 reaching about 4.0 and 4.5 volts in this example. The magnetic coupling is then produced mainly by the central portion of the spring 5, such that the signal is equal to a lower value of the plateau S3, equal to about 3.3 or 3.4 volts. When the magnetic coupling is produced mainly by the other end 8 of the spring 5, the signal returns approximately to a high value of the peak S5 that is in practice close to S4, or is sometimes a little higher. Finally, if the rod 1 is moved further through the detector 9, the signal becomes equal to a stable value S2, coupling being produced essentially by the cladding 2, and for which the value is slightly higher than S1.

The process according to the invention consists of recording values S4, S5 and S3 and determining the ratio

$$\frac{( S4 - S5 )}{S3} .$$

It has been observed that if excess energy is used to weld the plug 3, the value of S4 is lower. Therefore the inspection process consists of comparing the value of the ratio

$$\frac{( S4 - S5 )}{S3}$$

with a threshold, that may be −10% in the example considered but must be determined empirically in other cases, and to appraise whether or not the rods 1 comply with the manufacturing requirements, depending on whether this ratio is greater than or less than the threshold (in the example, less than the threshold). This curve is also used to determine the compressed length of spring 5 or the length of the chamber that contains it, by measuring the distance between the two peaks, and the presence of the spring 5, since no peak is observed if it is missing, and the measurement curve changes directly from the value S1 to the value S2.

The choice of the ratio

$$\frac{( S4 - S5 )}{S3}$$

as the acceptance criterion is based on the fact that the values of the peaks S4 and S5 do not depend only on the magnetic coupling of the rod 1 at the location sensitive to manufacturing defects, but also characteristics of the environment, the spring length and the detector itself. Therefore, it is better to weight these values S4 and S5 by the plateau value S3 that gives a sort of reference signal.

1. Method for the inspection of a nuclear fuel rod (1) with an end plug (3) welded to a cladding (2), a coil spring (5) being compressed between the plug (3) and the fuel (4), using an electromagnetic induction detector (9) along which the rod is moved, by measuring a detector output signal, characterised in that it consists of recording a value of the signal at a base portion (S3), obtained with non-adjacent spring coils, and other values of the signal at peaks (S4 and S5) adjacent to the plateau portion, and which apply maximum magnetic coupling, calculating a ratio
$$\frac{( S4 - S5 )}{S3}$$
of the values of the signal and accepting or rejecting the rod depending on whether the ratio is more than or less than a threshold.
